(19) United States
(12) Patent Application Publication
(10) Pub. No.: US 2023/0050548 A1
(43) Pub. Date: Feb. 16, 2023

(54) Knowledge Management System and Method

(71) Applicants: Melanie S. Ginn, Boynton Beach, FL (US); Karina Rincon, Newberry, FL (US)

(72) Inventors: Melanie S. Ginn, Boynton Beach, FL (US); Karina Rincon, Newberry, FL (US)

(21) Appl. No.: 17/886,284

(22) Filed: Aug. 11, 2022

Related U.S. Application Data
(60) Provisional application No. 63/231,979, filed on Aug. 11, 2021.

(51) Int. Cl. G06Q 50/20; G06F 16/28

(52) U.S. Cl. CPC G06Q 50/205; G06F 16/284

(57) ABSTRACT

A knowledge management system and method. The knowledge management system and method can have multi-industry applications with special suitability for program-based initiatives, research projects, healthcare sector programs, educational system programs, workforce development initiatives, and social service outcomes.

### PRIORITY

This application claims the priority of U.S. Provisional Patent Application 63/231,979, filed Aug. 11, 2021, and titled “Knowledge Management System and Method,” the entire disclosure of which is hereby incorporated by reference herein.

### TECHNICAL FIELD

The present disclosure relates to a web-based knowledge management system.

### BACKGROUND

Managing data, including taking in and exporting information, can present problems for web-based online knowledge management systems.

### BRIEF DESCRIPTION OF THE DRAWINGS

The following detailed description of embodiments of the present disclosure can be best understood when read in conjunction with the drawings enclosed herewith:

FIG. 1 is a schematic representation of an example system according to one embodiment of the disclosure.

FIGS. 2 is a representation of an example participant profile according to one embodiment of the disclosure.

FIG. 3 is a representation of an example enrollment tracker according to one embodiment of the disclosure.

FIG. 4 a representation of an example widget builder according to one embodiment of the disclosure;.

FIG. 5 a representation of an example chart according to one embodiment of the disclosure.

FIG. 6 is a representation of an example widget builder and related pie chart according to one embodiment of the disclosure.

FIG. 7 is a representation of an example pie chart according to one embodiment of the disclosure.

FIG. 8 is a representation of an example pie chart according to one embodiment of the disclosure.

FIG. 9 is a representation of an example widget builder and related table according to one embodiment of the disclosure.

FIG. 10 is a representation of an example widget builder for reports according to one embodiment of the disclosure.

FIG. 11 is a representation of an example task tracker according to one embodiment of the disclosure.

FIG. 12 is a representation of an example task planner according to one embodiment of the disclosure.

FIG. 13 is a schematic representation of a system and method according to one embodiment of the disclosure.

FIG. 14 is a representative internal report.

FIG. 15 is a representative external report.

FIG. 16 is a representative external report.

FIG. 17 is a schematic representation of Whole Child 360.

FIG. 18 is a diagram illustrating an exemplary system architecture for the system of FIG. 1.

FIG. 19 is a flowchart of a set of steps that may be performed with a system to automatically encrypt sensitive data at an application layer.

FIG. 20 is a flowchart of a set of steps that may be performed with a system to query a database for encrypted sensitive data at an application layer.

FIG. 21 is a screenshot of a student specific status interface.

FIG. 22 is a screenshot of a population status interface.

The embodiments set forth in the drawings are illustrative in nature and not intended to be limiting. Moreover, individual features of the drawings and the disclosure will be more fully apparent and understood in view of the detailed description.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific FIG. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Solutions to the problems associated with knowledge management systems are disclosed herein. In an embodiment, the disclosure relates to a HIPAA compliant system. In an embodiment, the disclosure relates to a cloud-based system. In an embodiment, the disclosure relates to a web-based system. In an embodiment, the disclosure relates to a HIPAA compliant, cloud-based, browser-based, user-friendly, and flexible system. In an embodiment the disclosure relates to methods and systems with mobile functionality, bank-level security, permission-based user access, and/or integration with electronic health records (EHR). The system and method can have multi-industry applications with special suitability for program-based initiatives, research projects, healthcare sector programs, educational system programs, workforce development initiatives, and social service outcomes.

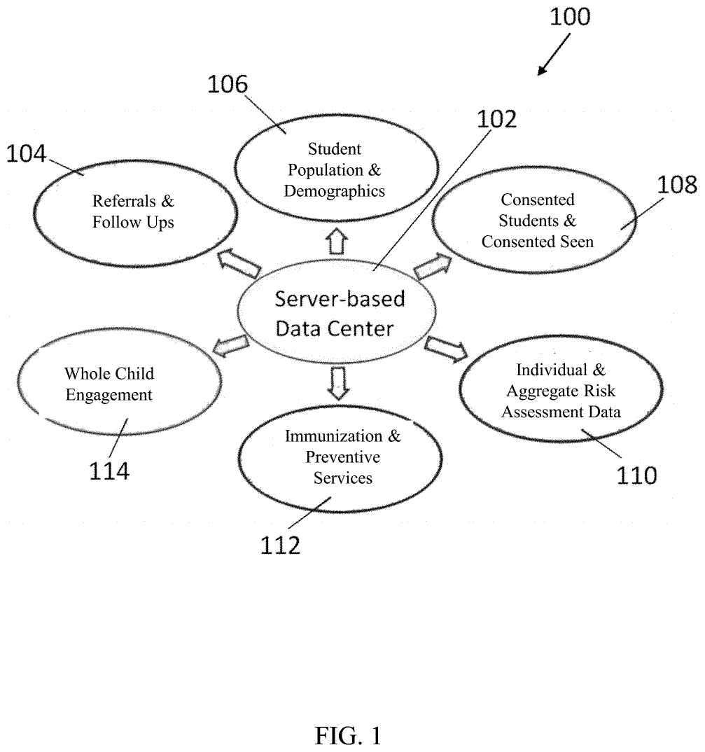

Referring now to FIG. 1, there is shown a schematic diagram indicating example benefit areas of the disclosed system and method. For example, a system (100) can operate from a server-based data center (102), such as a server hosted by Amazon Web Services (AWS). The server-based data center (102) can be FedRAMP and NIST 800-53 certified, a security certification high enough to allow the Federal Government and Federal Government contractors to leverage their services, and secure enough to be classified as a HIPAA compliant platform. The server based data center (102) can serve to manage data, for example data related to (depending on the industry application) referrals and follow-ups (104), student population and demographics (106) (e.g., such as a school roster including basic and/or demographic information for every student enrolled at a school), consented students and/or consented students seen (108), individual and/or aggregate risk assessment data (110), immunizations and preventive services (112), whole child engagement (114), and the like. Further, the server-based data center (102) can use automated brute-force detection to mitigate the risk of brute-force attacks being successful. Furthermore, sensitive user data can be encrypted using a Triple Data Encryption Algorithm (TDES).

At the software's user application level, organizational and role-based permissions can be available in the platform. There can be multiple user roles and permissions that are available at all user levels. Roles can be configured by an on-site administrator of the customer's choice or the customer can contract with a third party to manage this for them. Permissions are also granular enough to allow individual program level access controls.

In an example, the system (100) can provide for real-time cross tab reporting to keep track of pre and post surveys, assessments/questionnaires, services, activities, interventions, and outcomes; reporting on individual and aggregate data; planning, benchmarking, and measuring outcomes for tasks completed and pending; tracking of participants who are active within a particular program; managing a program's case managers/providers/employees' productivity.

In an example, the system (100) can also include one or more of the following: Mobile functionality—Intake and/or access data on the go using a smartphone or tablet; Dynamic customizable reporting widgets and dashboards—data and outcomes can be visualized in pie charts, bar charts, or data tables; Full customization—Customization of participant demographics, assessments, outcomes, services, activities, and anything else desired to be tracked; Bulk import and export of data in the form of Excel spreadsheets; Integration with other systems, such as EHR/EMR systems; Auto-calculations; Automated reports; Document upload; Bank-level security; Permission-based user access; Browser interface.

In an embodiment, the system (100) can include a MySQL database with PHP as the server-side language, JavaScript as the client-side language, and Symfony as the PHP MVC framework. The application can run on an open source called a LAMP stack: Linux, Apache, MySQL, PHP. The system (100) can track a multitude of data points including clients, services, referrals, employee productivity, and quantitative deliverables, while also highlighting the value and impact of the work system users do by providing easy access to real-time reports that showcase outcomes. The system (100) is uniquely flexible, allowing for filtering information to reflect a myriad of combinations of data points to tracking and providing custom reports with aggregate and individual data. For example, as described below, a user can use a widget builder to filter and display via charts, tables, and/or reports, various information relating to system data.

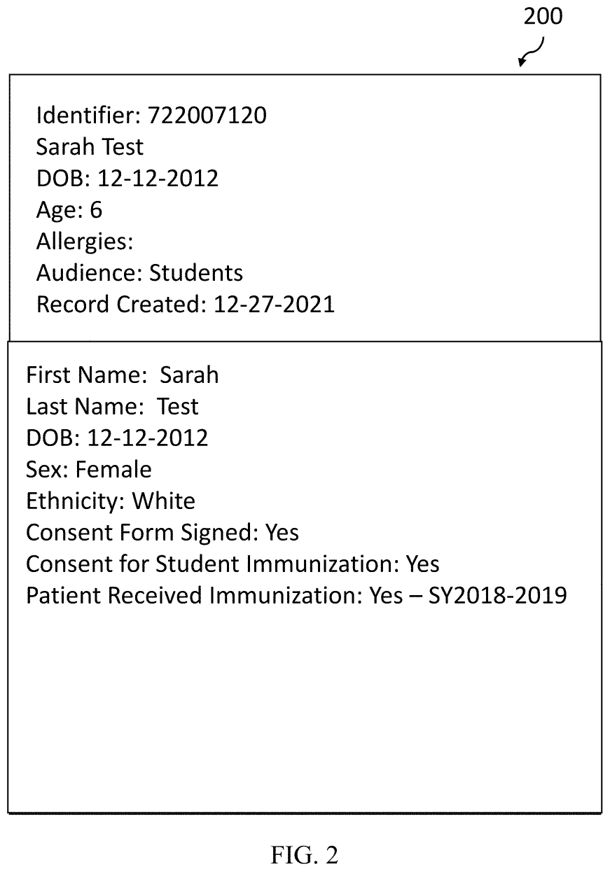

Example method components of system (100) are described to illustrate certain features and benefits. Participants in the system (100) can be enrolled and can have their participant data entered at a participant profile page (200), an example of which is shown in FIG. 2. The participant profile page (200) can have database fields related to system information for the particular program for which the system (100) is being used. For example, each participant can have in a participant profile page (200) identifying information including name, address, sex, ethnicity, birthdate, and a unique participant identifier. Further, information related to the participant's status, e.g., student, and medical history, e.g., allergies and immunizations, can be recorded. Additionally, information related to consent forms, consents, and gender can be recorded.

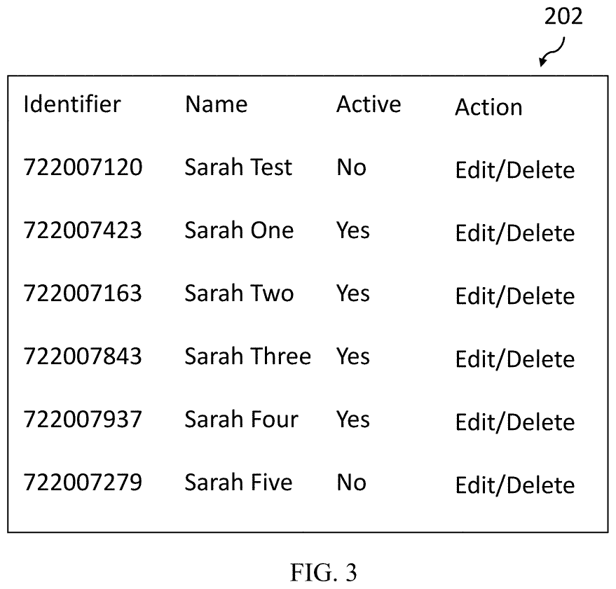

Another example component of the system (100) can be an enrollment tracker (202), an example of which is shown in FIG. 3. The enrollment tracker can record and show participants by one or all of their unique identifying number, name, date of birth, and status. The enrollment tracker can also indicate whether the participant is active or not, and can for administrative actions for each record, including “view,” “edit,” and “delete.”

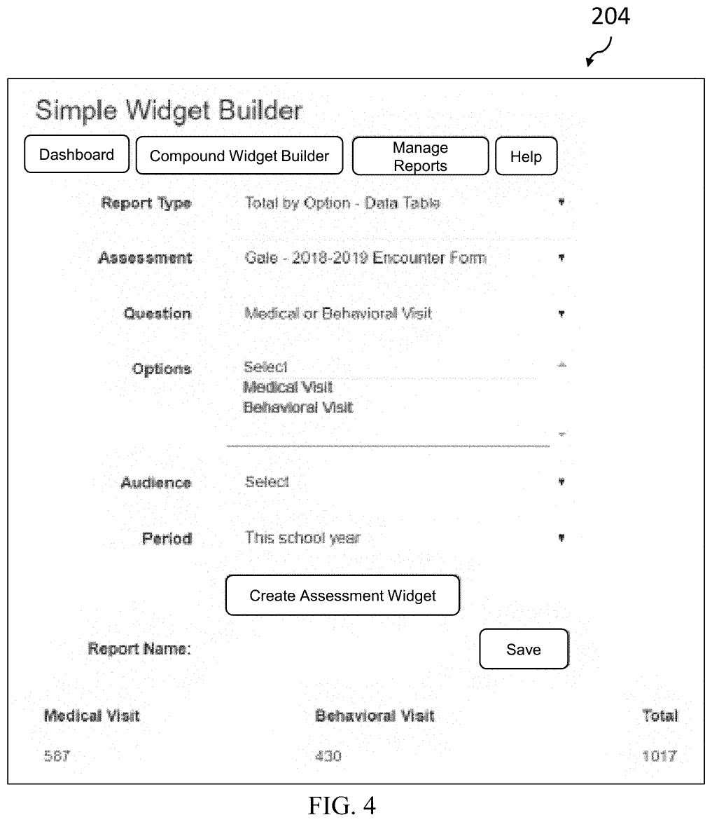

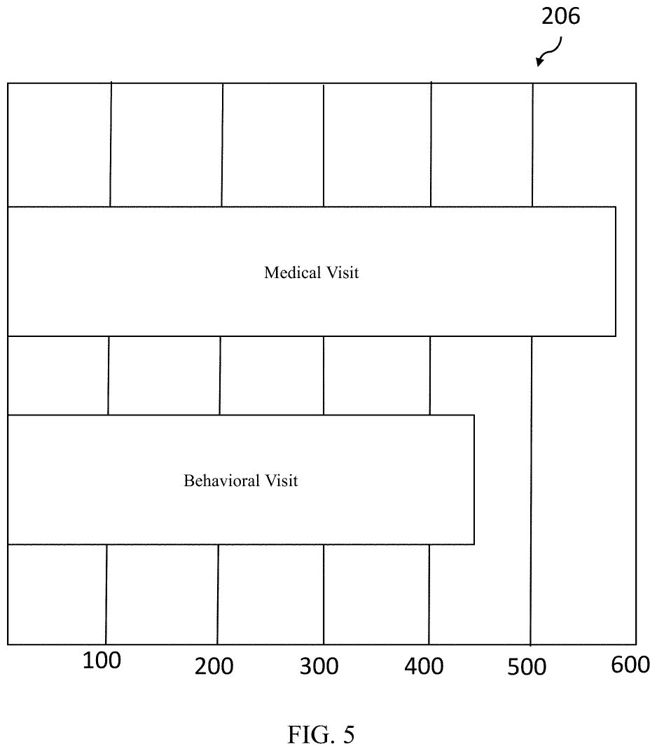

Various “widgets” can be built and utilized in the system (100). For example, as shown in FIG. 4, a widget builder component (204) permits a person, e.g., a system administrator, to build a widget that can, for example, report details of participants of the system (100). The widget builder component (204), for example, is shown as building a widget (206), shown in FIG. 5, which graphically depicts a representation of participant visits, i.e., medical visits and behavioral visits.

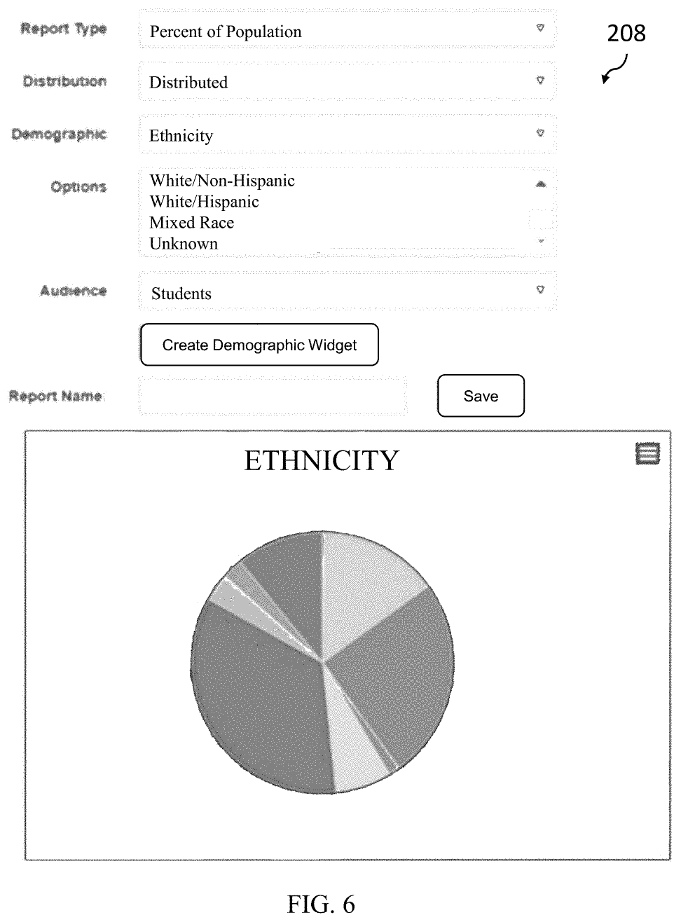

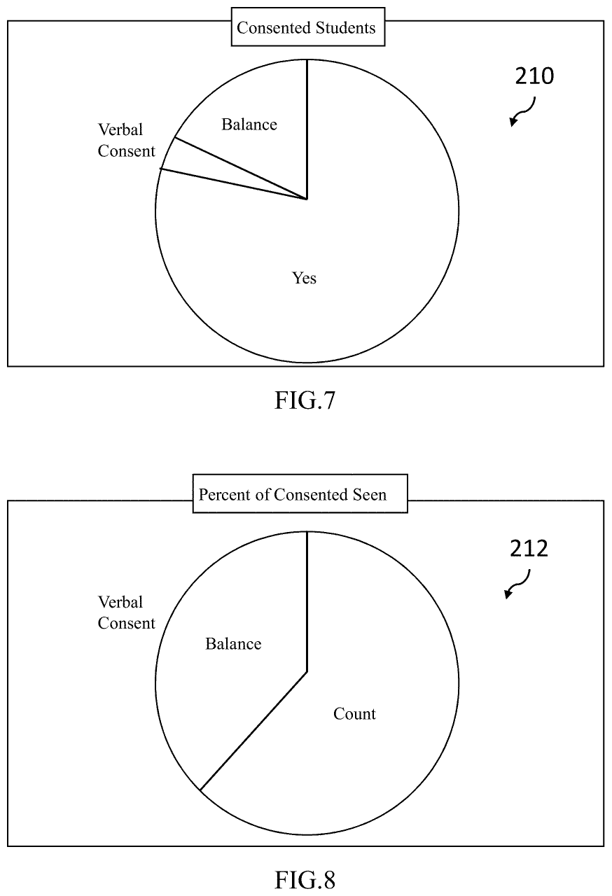

Another example of a widget builder component and a widget is shown in the sample diagram (208) of FIG. 6. Various database fields of information related to (in this example) ethnicity can be selected as options, and represented in, for example, a pie chart for visualization. Other demographic items can also be selected for pie charts, including charts based on percentages. Further sample diagrams are shown in FIGS. 7 and 8, showing a pie chart of consented students (210) and a pie chart of percent of consented seen (212), respectively.

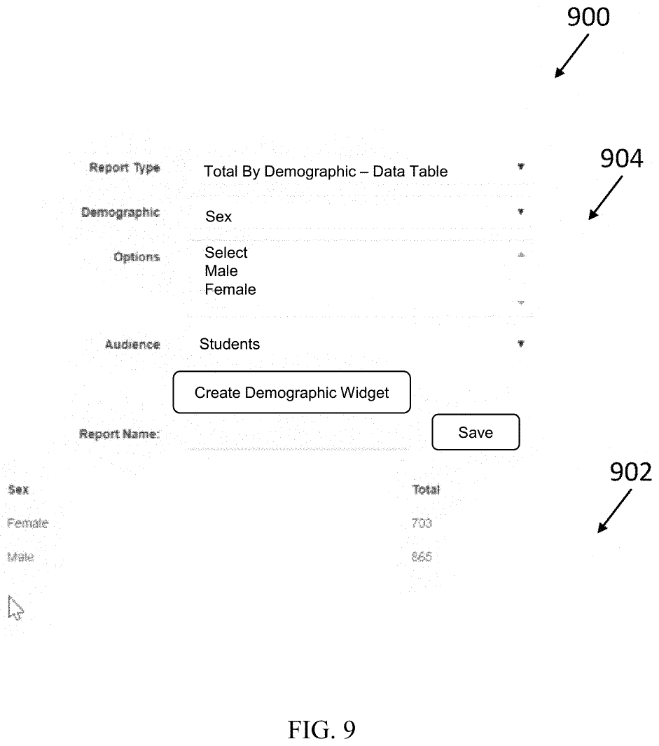

Another example of a widget builder component and a widget is shown in the sample diagram (900) of FIG. 9, which shows a table (902) built from information entered into database fields of the widget builder, indicated in FIG. 9 at (904).

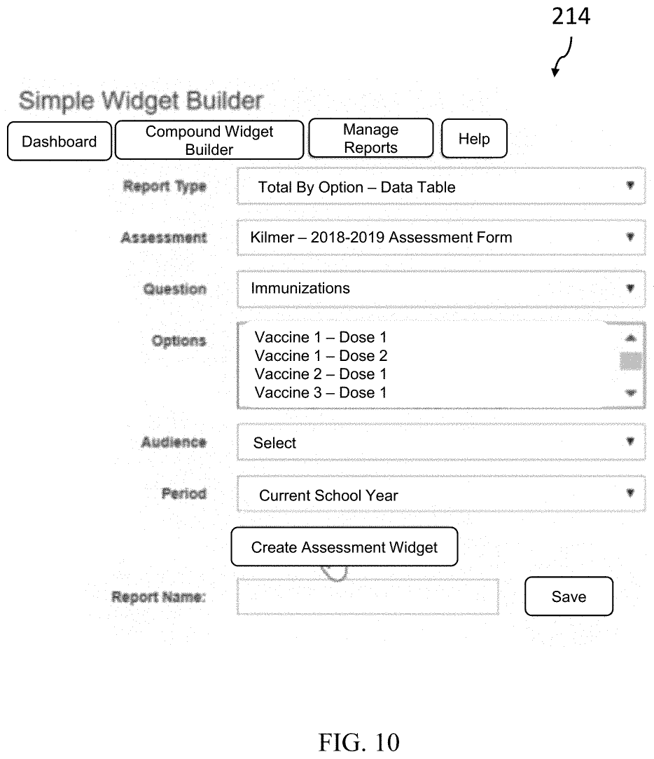

Another example of a widget builder component and a widget is shown in the sample diagram (214) of FIG. 10, which shows a widget builder for building a report, which can be displayed as an assessment widget.

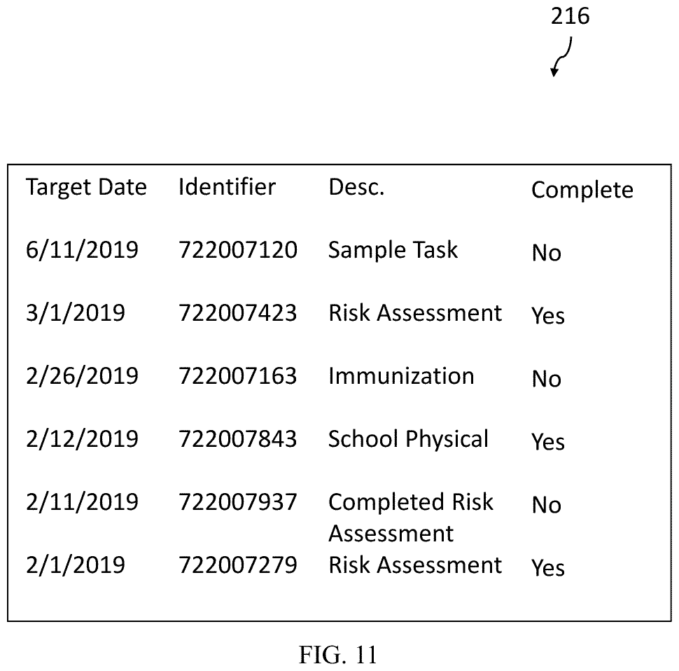

Referring now to FIG. 11, there is shown an example task tracker (216). The task tracker (216) can display tasks related to participants, and indicate, for example, if the tasks are complete or not. Tasks can be program specific, and can be such tasks as risk assessments, flu immunizations, school physicals, and the like.

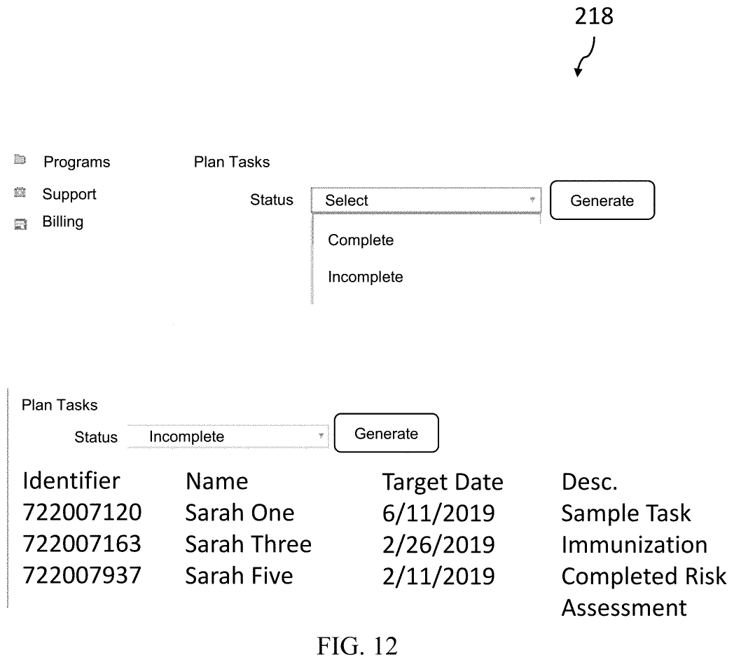

Referring now to FIG. 12, there is shown an example task planner (218). The task planner (218) can be used to plan tasks related to participants, and indicate, for example, if the dates the tasks are targeted for completion. Tasks can be program specific, and can be such tasks as risk assessments, flu immunizations, school physicals, and the like.

### Example 1: Medical Providers

The system (100) provides a software user license and training to medical provider organizations that operate student health centers, as a supplemental tool that is used to drive access to and use of health care. In supporting the model, the system (100) offers an easy approach for exporting reports in real-time with individual and/or aggregate data, which allows users to identify and follow-up on students' needs, not only at the individual level, but also at the population level, and to plan for early interventions based on those needs. The system (100) also works as a master database of a population as well as each school's population. It allows providers to easily track students consented, students consented who have and have not been seen, and students who have or have not received specific services, including risk assessments, flu and other immunizations, school physicals, and the like.

### Example 2: Business Operations

A user may use the system (100) to track student service utilization levels, interventions delivered, and provider productivity, which not only helps in ensuring quality, but also calculates encounters against operational factors to ensure goals are met and assist in evaluating the need for expanded resources. The applicant, via the system (100), also produces monthly report cards for each medical provider partner using aggregate, de-identified data gathered from the system (100), in order to highlight the monthly and year-to-date comparison of services provided, risk assessment information, and key interventions. The system (100) also tracks and reports on related school academic metrics and ratings, which is data that the school provides, among others.

### Example 3: Education

Education remains a critical social determinant in getting children and their families out of poverty and in improving their quality of life. The system (100) can be utilized to minimize or eliminate health-related barriers to learning. The system (100) utilized in a school setting is to be contrasted and distinguished from known school-based health centers (SBHCs) in that it can facilitate access to health and mental health services, as well as enhance behavioral health assessments and clinical management. Further, the system and method of the present disclosure provides access and engages all students and not just those who come in because of a health complaint. In an embodiment, the system and method focuses on academic outcomes for students, fully integrates into the school's practices, policies, and culture, and facilitates financial sustainability.

In general, the disclosed system can be distinguished from systems and practices of other SBHC's by addressing some or all of the following limitations or shortcomings of conventional approaches.

The system and method facilitates the improvement in academic achievement by improving the health of students, teachers and staff in a school setting. In an embodiment, the system and method can be implemented in the context of the Whole School, Whole Community, Whole Child (WSCC) model articulated by the Centers for Disease Control. The WSCC model assumes the child as the focus, with the health and educational needs of children strategically embedded within a school-wide approach that in turn reflects local community strengths and needs.

The system and method facilitates systemic, strategic transformation (district-level approach) through deployment of evidence-based, integrative health care practices embedded in a school environment and informed by community needs and resources. Thus, the school district can be fully engaged as a primary stakeholder partner in creating the necessary conditions and setting the expectations within the schools' leadership and among the teachers and staff to facilitate successful adaptation and integration of the health processes and staff on the ground in the school communities. In an embodiment, a designated facilitator can collaborate with district-level leadership to develop a comprehensive, system/district-wide strategy for student health and wellness initiatives and resources across the district for the purpose of reaching academic achievement goals. This process can include a comprehensive inventory and assessment of all health-related services in the district, which should be aligned to the commitment to the whole child/whole school values that make explicit linkages between health and education outcomes.

The system and method can be financially sustainable for certain conditions, such as numbers of participants consented and seen over the course of an academic year. For example, if a clinic associated with the system and method serves a population of at least about 500 students, and at least 90% of the students are consented and 100% of those consented are seen by the clinic over the course of the academic year, costs can be covered in a three-year period. In an embodiment, financial sustainability can be achieved by performing the following: research state Medicaid reimbursement and credentialing structures; develop preliminary budget for the clinic; establish pro forma budgets; manage budget against actual; execute marketing and engagement plan for consents.

Establishing the system and method disclosed herein as a permanent asset within a school can provide high-level organizational capacity that links health and education outcomes. In addition, it can provide school leadership the authority to provide the following in order to ensure its sustainability: visionary and effective leadership and management structures; extensive internal and external supports; development and allocation of adequate resources; supportive policies and procedures; and establishment of unifying, comprehensive standards to support best outcomes.

In an embodiment, the system and method can utilize trained and credentialed transdisciplinary staff who can be available during school hours to help students, staff, and students' families. The system and method can also be characterized by purpose-designed physical spaces that can be centrally located in a school building so that the clinic is easily visible, accessible, and/or viewed absent of stigma to students and teachers. An operating system can include one or more of: licensed medical provider (FNP or PA); licensed clinical social worker (LCSW or LICSW); a utilization and engagement director; licensed practical nurse (LPN) or certified medical assistant (CMA); registered nurse (RN); a health and wellness coordinator.

The system and method can collaborate with school leadership to realign practices and provide additional support for school staff in support of health and wellness. For example, the system and method, when implemented, can identify unknown student health issues early on through wellness screenings or to be an in-house referral for short-term interventions with students who may or may not be on Individual Education Plans (IEPs).

The system and method can utilize built-in accountability processes that helps drive improvements in practices and policies while also monitoring and tracking student health and education outcomes over time.

The system and method can implement processes and facilitate access to the conditions and resources that positively influence health, including historically excluded or marginalized groups. These conditions and resources that influence health are often referred to as the social determinants of health (SDOH). Specifically, social determinants of health are conditions in the environment in which people live, learn, work, play, worship, and age that affect a wide range of health, functioning, and quality of life outcomes and risks. Examples of social determinants of health include quality of education, public safety, access to health care services, social support, and residential segregation, among others. In an embodiment, therefore, the system and method can be practiced by being implemented in schools that serve students who are economically disadvantaged and are more likely to be chronically stressed, tired, hungry, and have vision and hearing problems, all factors that put a student at risk for academic failure.

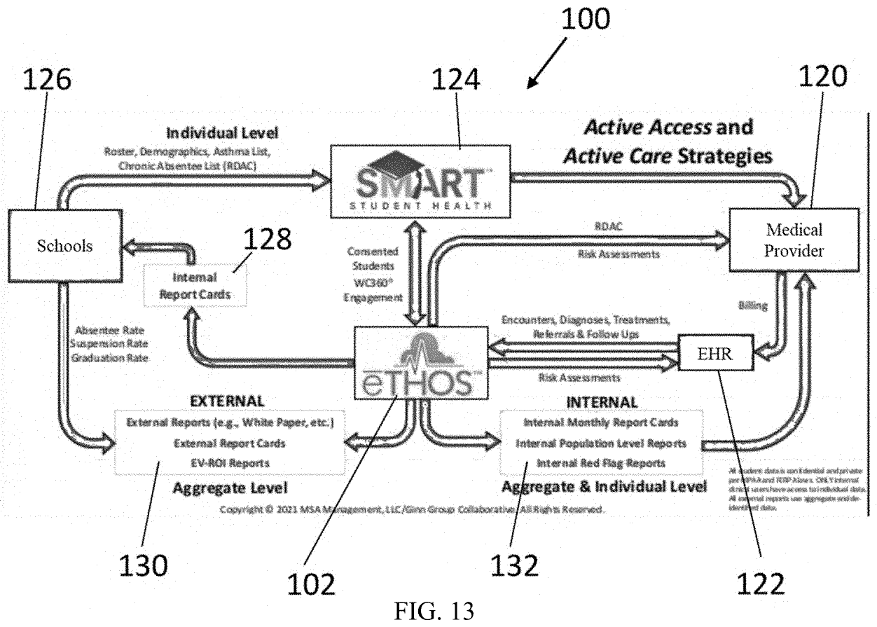

Referring now to FIG. 13, there is shown a schematic illustration of an example embodiment of a system (100) and various methods that can be implemented in the system (100). In general, a method of use of the system can be any processes implemented on a flow path indicated by arrows. In this illustrated embodiment, the server-based data center (102) can be a HIPAA-compliant data collection tool. The server-based data center can be or utilize any of known computers, data communication, web-based, cloud-based, wireless, and related technologies. The server-based data center (102) can allow real-time intake and export of aggregate and individual data. The server-based data center can track and report numerous data points, for example, data related to students, services, referrals, productivity, and the like. In an embodiment, the server-based data center (102) can incorporate and implement whole child health management, including features that manage personal health costs (medical and pharmaceutical costs), diagnosed illnesses, IEP records, attendance and grade records, hygiene habits, risky behaviors, costs associated with undiagnosed or preventable illnesses, and information related to health conditions such as ADHD, suicide ideation, chronic diseases, risky behaviors, and/or unhealthy relationships.

In some implementations, the server based data center (102) is a data collection tool developed to manage population health strategies for models and clinics described herein. However, the data collection tool is fully customizable for applications in a wide variety of service and program-based operations. In some implementations, the data collection tool may be implemented in the MySQL database with PHP as the server-side language, JavaScript as the client-side language, and Symfony as the PHP MVC framework. Such an application runs on an open source called a LAMP stack: Linux, Apache, MySQL, and PHP.

In some implementations, the data collection tool can track a multitude of data points including clients, services, referrals, employee productivity, and quantitative deliverables, while also guiding and highlighting the value and impact of the work users do by providing easy access to real-time reports that showcase outcomes. The system is flexible, allowing for filtering information to reflect a myriad of combinations of data points, as well as tracking and providing custom reports with aggregate and individual data.

Additionally, some implementations of the server-based data center (102) can include signature program dashboards that showcase built-in dynamic reporting widgets (for example, as discussed above) that can be automatically updated in real-time as new data is entered in the system. These can provide a snapshot of the most important data for participating schools or clinics, for example. Data can include: Total Population; Consent Rate; Consented Seen Rate; Consented for Flu Shot Rate: % of Flu Shots Administered; % of Students Risk Assessed; Aggregate Chart for the Program with Drill Down Functionality for Individual Detail; YTD Bar Chart for Total Encounters (Medical vs. Behavioral) with Running YTD Averages; and/or Line Chart for Daily Encounters (Medical vs. Behavioral) for Current Month with Running Daily Averages. Furthermore, the server based data center (102) can offer charts that display a month-to-month yearly comparison of medical and behavioral encounters, so teams can see how they're doing in the current year in relation to the prior year. Other items, such as chronic conditions, number of acute visits, whether students are consented for a flu shot and whether those consented students have already received their flu shot can be displayed at the top of participant profiles, always easily accessible to providers and staff utilizing the platform.

The server-based data center (102), can be hosted through a server environment such as the Amazon Web Services (AWS) data center from the eastern region of the United States. In some implementations, datacenters are FedRAMP and NIST 800-53 certified, a security certification high enough to allow the Federal Government and Federal Government contractors to leverage their services, and secure enough to be classified as a HIPAA compliant platform. Additionally, the servers use automated brute-force detection to mitigate the risk of brute-force attacks being successful. Furthermore, sensitive user data is encrypted using Triple DES, the same algorithm that banks use to protect data.

At the software's user application level, organizational and role-based permissions are available in the platform. There are multiple user roles and permissions that are available at all user levels. Roles can be configured by an on-site administrator of the customer's choice or the customer can contract with a third party to manage this for them. Permissions can also be granular enough to allow individual program level access controls.

With further reference to FIG. 13, the server-based data center (102) can communicate and process information with medical providers (120), including electronic health records (EHR) (122). The server-based data center (102) can provide to the medical providers information such as internal monthly report cards, red flag reports, and other reports. The server-based data center (102) also processes information to and from school clinics (124), such as school-based health centers focusing on the health and well-being of students, which can also be in data communication with medical providers (120).

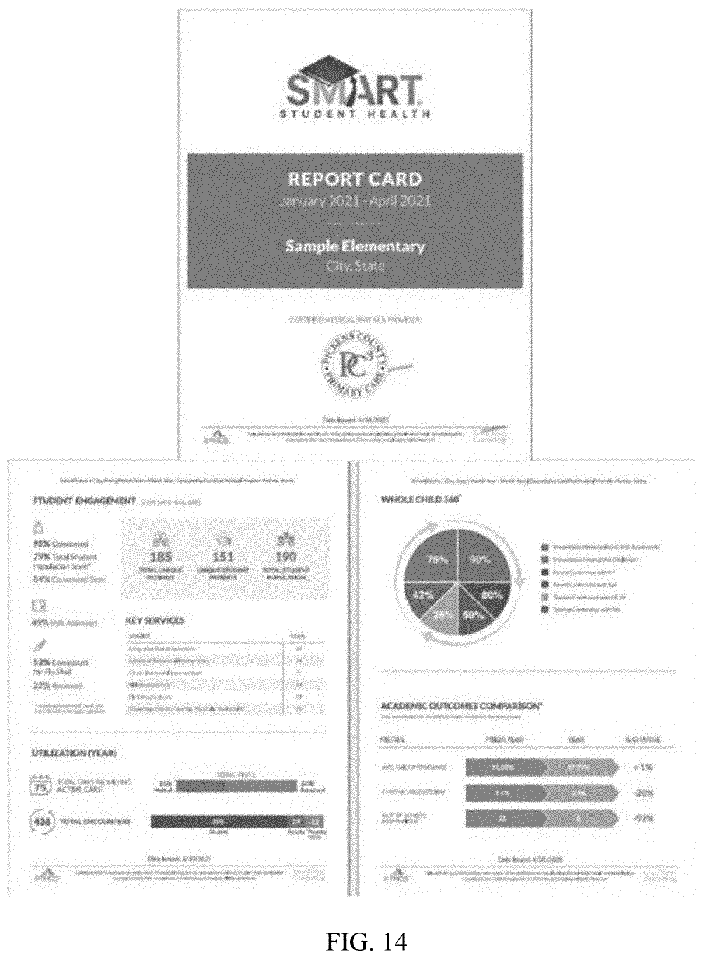

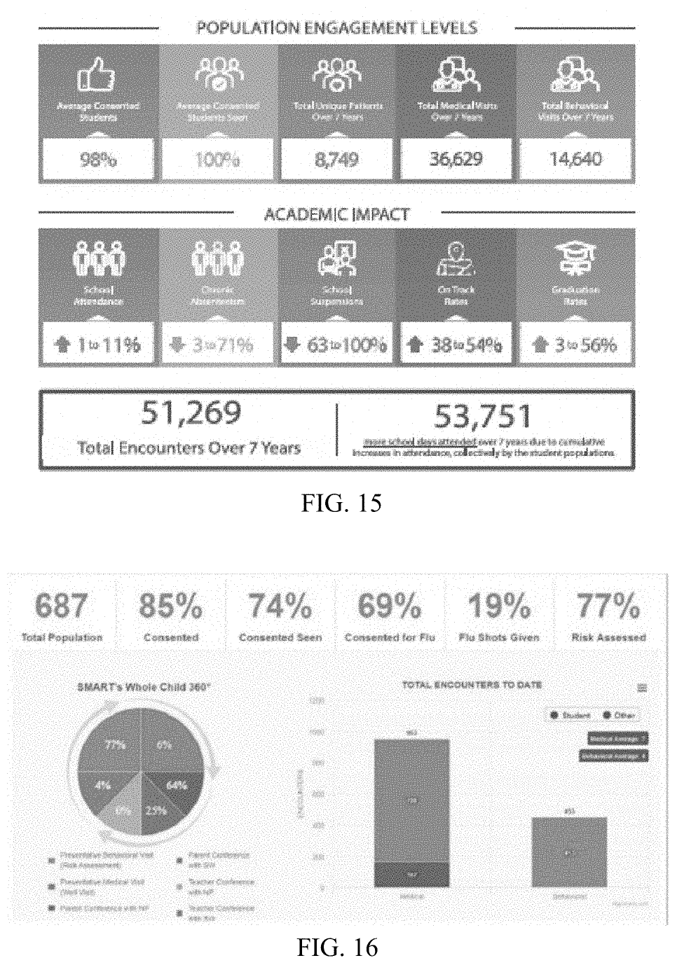

The server-based data center (102) processes information with schools (126), including at an individual level and an aggregate level. The server-based data center (102) can automatically produce (e.g., based upon a schedule or based upon a user initiated action) internal report cards of performance (128) as well as external reports (130). An example of an internal report card (128) is shown in FIG. 14. As shown, representative components of an internal report can include data related to student engagement, utilization, whole child information, and academic outcomes comparisons. Representative examples of an external report (130) are shown in FIGS. 15 and 16. As shown representative components of an external report can include aggregate information including data related to population engagement levels. Further aggregate and individual level reports (132) can include internal red flag reports that can be used by, for example, the medical provider (120) for appropriate intervention, if necessary. Other communicative interactions with the medical provider (120) can include risk assessments, encounters, diagnoses, treatments, referrals, follow ups, and billing information.

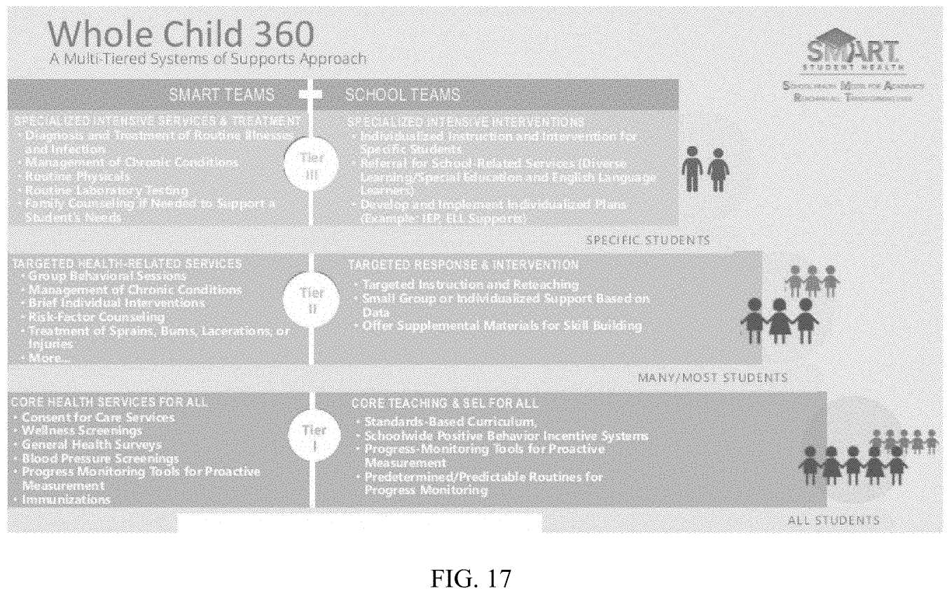

Referring now to FIG. 17, there is shown a representative whole child information useful in the system and method of the present disclosure. The shown example includes a multi-tiered system of support (MTSS). The whole child information can include data from clinic teams and school-based teams, and can include information that relates to specific students, many students, and all students. As illustrated by the MTSS Approach graphic of FIG. 17, platform teams work in conjunction with school teams to offer up resources and services at the Tier 1 (all students), Tier 2 (many/most students), and Tier 3 (specific students) levels. Particularly at the Tier 1 level, the clinic staff can be especially helpful to school teams through early identification of student health and academic issues, since clinics aim to consent nearly 100% of the student population and conduct wellness screenings and general health surveys for all consented students. The information gleaned from these clinic encounters can then inform how school resources can support students more efficaciously.

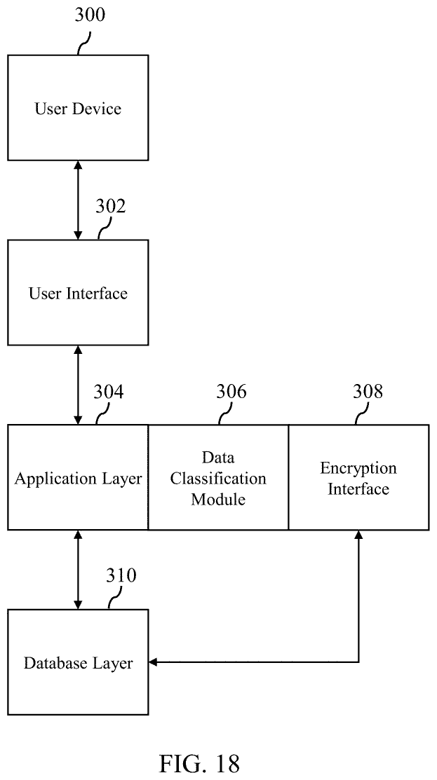

Due to the nature and use of the system (100) described above, data privacy and data security features may advantageously be implemented with the system in order to protect student information and electronic health records. As an example, FIG. 18 illustrates aspects of a system architecture that may be implemented with the system of FIG. 1 to provide increased data security and privacy. The architecture includes a database layer (310) that includes one or more databases or other data repositories, an application layer (304) configured to manage individual user sessions, query from and write to the database layer (310), provide information for and perform operations related to a user interface (302), and other business logic and related functions. A user interface (302) comprises a web portal, software application, or other application that may be provided to a user device (300) to display information to users and receive input from users. The user device (300) may be, for example, a personal computer, laptop, smartphone, tablet computer, or other computing device having a processor, memory, display, communication devices, and other components as may be useful to send, receive, process, manipulate, and store data over a network and/or with locally connected devices.

While the application layer (304) may be in direct communication with the database layer (310) for some operations, the application layer (304) also includes a data classification module (306) as well as an encryption interface (308), with the encryption interface (308) providing an alternate method of querying and writing to the database layer (310), as will be described in more detail below. The data classification module (306) is pre-configured with descriptions of a set of data types, and may also be pre-configured with a set of rules for analyzing data and determining a data type from the set of data types that applies to the data. The data classification module (306) may be configured such that all data passing into the application layer (304) passes through the data classification module (306) so that a data type can be confirmed if already present and associated with the data, or may be assigned if not.

In some implementations, the system (100) provides tools and interfaces usable by a user of the system to configure certain aspects and activities of the system (100), such as the user defined widgets described above. In some implementations, the system (100) provides interfaces allowing surveys, assessments, and other content to be distributed to one or many students in the form of electronic surveys or questionnaires, including distributing pre-configured content and creating new content. For example, a user of the system may create a survey or assessment to be distributed to students using a graphical interface and guided tool, and may customize each question and corresponding response options in an extremely flexible manner (e.g., questions may prompt students for their name, DOB, immunization status, and other information that may already be associated with the system, or may prompt students for feedback relating to their physical or mental well-being, for example, while response options may be free-form text inputs, drop down menus, checkboxes, radio buttons, or other input and response elements).

In such implementations, an additional function of the data classification module (306) is to enforce data typing upon custom surveys, assessments, or other forms that are created by users of the system (100) using such interfaces. For example, where a user configures a form to request the respondent's name, DOB, immunization status, or other sensitive information (e.g., sensitive information may vary, but typically includes at least “Protected Health Information” as that term is defined by HIPAA, and “Personal Information” as that term is defined by the General Data Protection Regulation or “GDPR”), the user will be required to select and associate a data type with that question and response (e.g., the data types that are selectable may be fairly specific, such as “student name” or “date of birth”, or may be more generic such as “sensitive student information”). Other examples of data types may include, for example, Names, Dates, except year, Telephone numbers, Geographic data, FAX numbers, Social Security numbers, Email addresses, Medical record numbers, Account numbers, Health plan beneficiary numbers, Certificate/license numbers, Vehicle identifiers and serial numbers including license plates, Web URLs, Device identifiers and serial numbers, Internet protocol addresses, Full face photos and comparable images, Biometric identifiers (i.e. retinal scan, fingerprints), Any unique identifying number or code (even where arbitrarily assigned).

In this manner, the data classification module (306) is capable of tightly controlling the flow of data into the system (100), such that all received inputs are at least initially typed. In some implementations the module may be additionally configured to perform type based verifications of received data (e.g., either locally to the application layer, or by dynamically producing and pushing appropriate scripts and other configurations to the user interface, such that when a user submits input via an input element classified as “student name” the content of that input may be evaluated by the user interface (302) locally to the user device (300), when received at the application layer (304), or both).

When receiving or processing data of certain types (e.g., non-sensitive data, such as arbitrary identifiers, non-specific dates, or other impersonal information), the application layer (304) may write that data directly to the database layer (310) and/or directly query the database layer (310) for that data (e.g., when querying a table for non-sensitive data, the database may be queried for specific keys, ranges of values, etc.). However, when receiving or processing data that is typed as sensitive data (e.g., student name, date of birth, immunization status, health records, etc.), the application layer (304) will instead interact with the database layer (310) via the encryption interface (308). When writing data to the database via the encryption interface (308), the data will be automatically encrypted, and the encrypted data will be written to the database layer (310).

This presents certain problems when querying the database layer (310) for results based on encrypted data fields. For example, where a student's name is stored in the database in plain text, various tables of the database may be queried using that student's plain text name to receive various records related to the student. Where such data is encrypted within the database, the application layer (304) must query the database in a different manner in order to receive the desired records, as will be described in more detail below. While this approach is unconventional and can result in inefficiencies in certain database operations (e.g., increased result set size, required pre- and post-processing of result sets), such an implementation advantageously protects the student or patient sensitive data while it is at rest within the database, and prevents unauthorized direct access to the data (e.g., a bad actor accessing a database with many plain-text fields may broadly query the database based upon a student name or other personal information in order to gather significant additional information on that student). Thus, instead of receiving large sets of personal information for some or all of the students, an unauthorized user of the database will instead retrieve meaningless and apparently arbitrary strings of data, with no readily available way to decrypt the data via the logic that is separately compartmented in the application layer (304) and encryption interface (308).

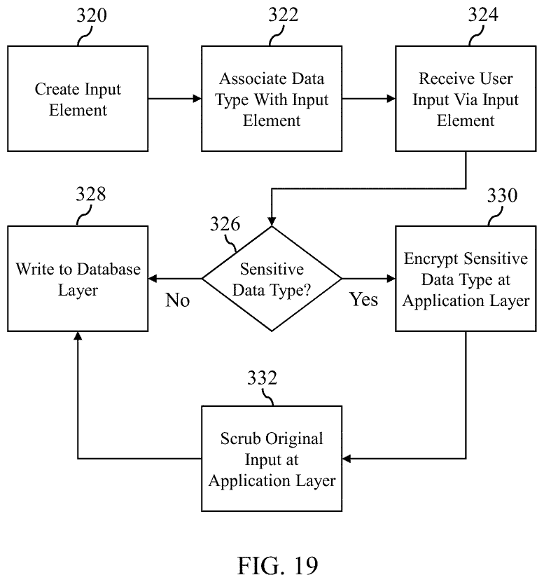

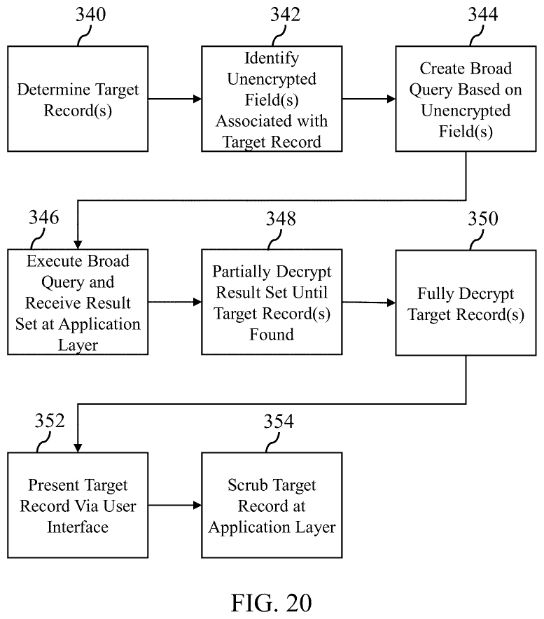

FIGS. 19 and 20 each provide examples of steps that may be performed when writing encrypted data to and reading encrypted data from a database in an architecture such as that illustrated by FIG. 18. With reference to FIG. 19, that figure illustrates steps that may be performed during a write operation. When creating (320) an input element, such as a text submission box, menu selection, checkbox, radio button, or other input element, the system may associate (322) a data type with that input element (e.g., such as described in relation to the data classification module (306)). The data type may be selected from a pre-configured list of types as has been described, and each data type may be associated by the system with being sensitive, non-sensitive, highly sensitive, or other classifications as may be desired. The data classification module (306) may enforce data typing on user generated custom forms (e.g., surveys, questionnaires, or other interfaces), and may also be configured to enforce data typing on forms more generally at the user interface level (e.g., even where an input element is created and deployed by a system administrator user bypassing custom form generation interfaces and tools, the application layer (304) may be configured to identify such input elements in HTML or other code prior to their display, and may automatically assign a data type, or prevent the input element from displaying and/or receiving input until a data type is assigned and the code is redeployed).

The system may receive (324) user inputs at the application layer (304) via input elements that are presented via the user interface (302), and may analyze the received inputs to determine whether some or all of the content in the input stream or form is of a sensitive data type (326). Where no sensitive data types are present (326), the application layer (304) may write (328) the received inputs to the database layer. Where analysis of the received inputs (e.g., by the data classification module (306) of the application layer (304)) determines that sensitive data types are present (326), the sensitive data may be automatically encrypted (330) at the application layer and the originally received sensitive data may be scrubbed (332) from the application layer. The system may then write (328) the encrypted input to the database layer. In some implementations, the database schema may be configured such that encrypted sensitive data (e.g., a student name, birthdate, immunization status) is only written to the database in records that solely contain encrypted data. For example, a student birthdate may be encrypted and written to a database table, with the primary key of that table also being encrypted. In this manner, a person gaining unauthorized access to the database will be unable to cross-link between tables based upon an unencrypted primary key (e.g., access to a primary key such as a student identifier number would allow for all of that student's encrypted data fields to be gathered).

Turning now to FIG. 20, that figure shows a read operation to retrieve specific encrypted target records from the database. The system may determine (340) which target record(s) are needed from the database based upon the current state or session at the application layer (304). As an example, where a user selects to a see list of all students that are fully immunized, or selects to see a list of complete and incomplete tasks for a particular student, the system may determine the target record(s) based upon that user selection and a pre-configured understanding of the database schema in which the records are stored. The system may also identify (342) one or more unencrypted fields associated with the target record(s) (e.g., while student name, birthdate, and immunization status may be encrypted, the school, grade, class, or other information associated with the student may be unencrypted). The system may then create (344) a broad query statement based on the unencrypted fields (342) associated with the target records. The broad query statement is created and configured to request a result set from the database that is certain to include the target record(s), but that is likely to also include additional extraneous records beyond the target record(s) (e.g., a broad query to retrieve information for a single student may return an encrypted result set of information for that single student as well as all other students in their class or grade). The system may then execute (346) the broad query and receive the result set at the application layer (304).

At the application layer (304) and/or by the encryption interface (308), the system may then iterate through the rows or records of the received (346) result set and partially decrypt (348) each row or record the target record(s) are each found, with the extraneous records being discarded. As an example, where students are each assigned an arbitrary identifier that is encrypted in the database, and the target record is all information for a student associated with that identifier, the system may iterate through the result set from the broad query decrypting (348) only that arbitrary identifier field until an identifier matching the target identifier is found, and all other records of the result set may then be discarded. Once one or more target record(s) are identified (348), the system may fully decrypt (350) some or all of the additional fields associated with that record and reconstitute the desired fully decrypted record on the application layer (304). Some or all of the content of the decrypted target record may then be presented (352) via the user interface or used for other purpose at the application layer. Unutilized portions of the result set, as well as decrypted target records stored at the application layer (304), may be immediately discarded (354) once they are no longer needed (e.g., such as after presentation (352) of the target record), or may be temporarily stored in that specific user session and scrubbed (354) when that session expires or ends (e.g., after the user logs out, after the passage of a certain amount of time or inactive time, etc.).

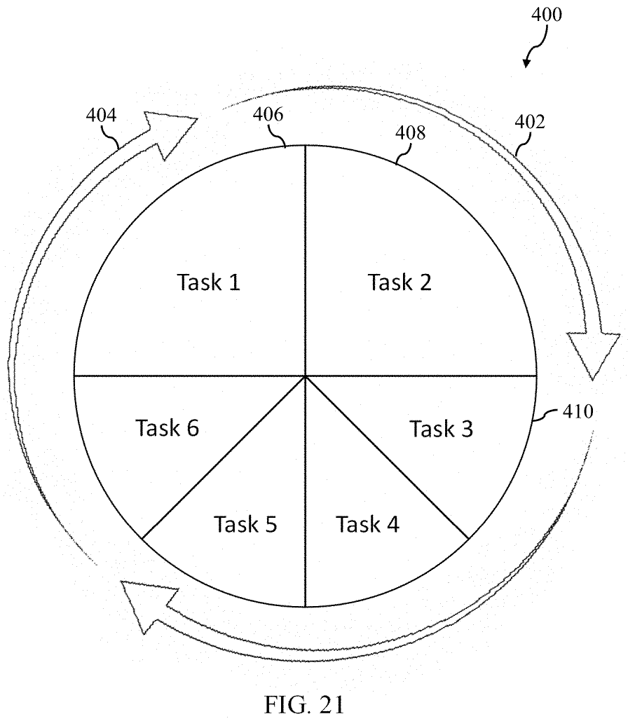

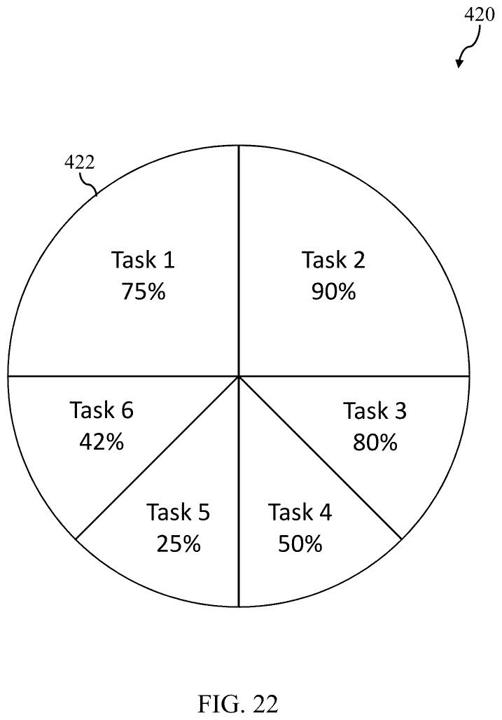

FIG. 21 is a screenshot of a student specific status interface (400) that may be displayed in a user interface alone or in combination with other user interface features described herein. The student specific status interface (400) provides a visually interactive display of a particular students status related to particular tasks, as well as a status of any required consents or other pre-requisites for completing those tasks, and may be displayed to a user of the system that is inquiring about a particular student. The interface includes a set of border features (402, 404) that surround the primarily circular control. The set of border features may be displayed with one or more visual characteristics depending upon whether certain pre-requisites for the tasks have been completed. Each border feature (402, 404) may share the same visual characteristics where they are prerequisites for all of the tasks, or may have separate characteristics where they relate to specific tasks (e.g., the first border feature (402) may relate specifically to task 2 (408), while the second border feature (404) may relate specifically to task 1 (406) and task 6). In some implementations, the border features (402, 404) indicate whether parental consent has been received for the particular student, and may be displayed in a varying color, pattern, or other appearance based on the status of consent (e.g., red may indicate no consent received, yellow may indicate verbal consent, and green may indicate that written consent has been received).

The portions of the circle associated with each task, such as task 1 (406), task 2 (408), and task 3 (410) may be similarly visually styled and displayed based upon the status of those tasks for the particular student. Examples of tasks will vary by implementation, and may include a preventative behavioral visit, a preventive medical visit, a parent conference with a nurse practitioner, a parent conference with a social worker, a teacher conference with a nurse practitioner, a teacher conference with a social worker, completion of an immunization, completion of a physical, and other tasks. As further example, where task 1 (406) relates to immunization, displaying that portion in green may indicate that the immunization has been complete, while displaying task 2 (408) in red may indicate that a different task, such as a preventive medical visit, has not been completed. Where a certain task has multiple steps or stages, the corresponding portion may be displayed in a varying brightness, gradient, or depth of color to indicate the extent of completion (e.g., full completion is a deep vivid green, while partial completion is a faded green).

The interface (400) advantageously communicates the unique data provided by the system to a user in a manner that matches their approach to the data—the first visual cue is the set of border features (402, 404), which indicate whether other tasks may be initiated or completed, with the secondary set of visual cues being the interior portions of the circle for each task, such that a user can at a quick glance determine what action if any is needed for that particular student. In some implementations, some or all visual elements (e.g., the border features and circle portions for each ask) may be clicked upon by the user to navigate to another page or portion of the system at which the user may address that specific prerequisite or consent. As an example, where the border feature (402) is red indicating no consent, the user may click that border feature in order to navigate to a page from which a consent form may be electronically or physically mailed to that student's parent or guardian. As another example, where task 1 (406) is associated with an immunization and is displayed as red indicating incomplete, the task 1 (406) portion may be clicked to navigate directly to a page or interface from which immunization may be scheduled or requested for that student. Other examples of “drill down” navigation features such as those outlined above may include navigation of interfaces similar to that displayed by FIG. 16, where a customer interaction with the box, number, or text for Total Population, Consented, Consented Seen, Consented for Flu (or other immunization), Flu Shots Given (or other immunization), Risk Assessed, and so on, causes the interface to navigate to a listing of a related student population (e.g., total population, consented population, unconsented population, immunized population, non-immunized population, etc.).

FIG. 22 is a screenshot of a population status interface (420) sharing some similarities with the single student interface (400). The population interface (420) displays the circular task representation discussed above in the context of FIG. 21 with each portion (422) corresponding to a particular task, and which may correspond to the same tasks as those displayed the single student interface. In addition to a task description (e.g., preventive medical care), each task portion (422) also displays a percentage (e.g., 75%) that indicates class-wide, grade-wide, or school-wide completion of that task (e.g., 75% of students at the school have completed the preventative medical care task). The multi-student interface (420) may be displayed individually or in combination with other interface features described herein, and/or may be incorporated in automatically generated reports and other interfaces as has been described above. In some implementations, a task portion (422) may be clicked upon to display or navigate to a page that displays a list of the entire student population that has completed that task (e.g., the 75% of students that have completed the preventive care task) or the inverse (e.g., the 25% of students that have not completed the preventive care task).

It is noted that terms like “specifically,” “preferably,” “commonly,” and “typically” are not utilized herein to limit the scope of the claimed disclosure or to imply that certain features are critical, essential, or even important to the structure or function of the claimed disclosure. Rather, these terms are merely intended to highlight alternative or additional features that may or may not be utilized in a particular embodiment of the present disclosure. It is also noted that terms like “substantially” and “about” are utilized herein to represent the inherent degree of uncertainty that may be attributed to any quantitative comparison, value, measurement, or other representation.

Having described the disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

All documents cited in the Detailed Description of the Disclosure are, in relevant part, incorporated herein by reference; the citation of any document is not to be construed as an admission that it is prior art with respect to the present disclosure. To the extent that any meaning or definition of a term in this written document conflicts with any meaning or definition of the term in a document incorporated by reference, the meaning or definition assigned to the term in this written document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

1. A system comprising:
(a) a server including a processor and a memory;
(b) a user device comprising a display and in communication with the server;
(c) a system architecture implemented by the server comprising an application layer and a database layer, wherein the database layer is configured to store a plurality of student datasets corresponding to a population of students, wherein each student dataset is associated with one student of the population of students, and comprises a task dataset indicating whether any of a plurality of tasks have been performed with that student, a consent status indicating whether consent has been received for performing any of the plurality of tasks with that student, and a set of student information describing personal information and demographic information of that student;
wherein the processor is configured to:
cause a population status interface to display, on the display of the user device, comprising a description of the plurality of tasks and a completion indicator for each of the plurality of tasks that is based on the task datasets for the plurality of student datasets;
(ii) based on a first user input selecting a task portion of the population status interface corresponding to a task of the plurality of tasks, cause a student population interface to display comprising a description of the population of students and, for each student, a description of whether any of the plurality of tasks have been performed with that student; and
(iii) based on a second user input selecting a student of the population of students via the student population interface, cause a student specific status interface to display based on a student dataset of the plurality of student datasets for the student, wherein the student specific status interface comprises the description of the plurality of tasks, a graphical consent indication based on the consent status, and a graphical completion indication based on the task dataset.

2. The system of claim 1, wherein the plurality of tasks comprise a preventative behavioral visit, a preventative medical visit, a parent conference with a nurse practitioner, a parent conference with a social worker, a teacher conference with a nurse practitioner, and a teacher conference with a social worker.

3. The system of claim 1, wherein the set of student information comprises a student name, a student birthdate, a description of student immunization status, and a description of student medical status.

4. The system of claim 1, wherein the application layer is configured to:
(a) receive personal information for a new student;
(b) encrypt the personal information; and
(c) add a new student dataset to the plurality of student datasets in the database layer, and add the encrypted personal information to the set of student information for the new student.

5. The system of claim 4, wherein all personal information stored within the set of student information for each of the plurality of student datasets in the database layer is encrypted.

6. The system of claim 5, wherein the application layer is configured to, when querying the database layer for a target student record based upon a database key comprising fields that are encrypted within the database layer:
(a) based upon the database key, create and execute a broad query that is configured to retrieve a broad query result set that contains the target student record and at least one other student record;
(b) for records of the broad query result set, decrypt fields associated with the database key until the target student record is identified; and
(c) in response to identifying the target student record, decrypt all of the fields of the target student record.

7. The system of claim 6, wherein the application layer is configured to immediately cease decrypting records of the broad query result set after identifying the target student record.

8. The system of claim 7, wherein the decrypted target student record is temporarily stored by the application layer within a particular user session.

9. The system of claim 1, wherein the population status interface comprises a geometric shape divided into a plurality of portions that correspond to the plurality of tasks and include the task portion, and the plurality of portions contain the description of the corresponding task and the completion indicator of the corresponding task.

9. The system of claim 1, wherein the population status interface comprises a geometric shape divided into a plurality of portions that correspond to the plurality of tasks and include the task portion, and the plurality of portions contain the description of the corresponding task and the completion indicator of the corresponding task.

10. The system of claim 9, wherein the student specific status interface comprises:
(a) the geometric shape divided into the plurality of portions corresponds that correspond to the plurality of tasks;
(b) the plurality of portions containing the corresponding graphical completion indication; and
(c) the graphical consent indication substantially surrounds the geometric shape.

11. The system of claim 1, wherein the student specific status interface comprises:
(a) a geometric shape divided into a plurality of portions that correspond to the plurality of tasks;
(b) the plurality of portions containing the description of the corresponding task and comprising the graphical completion indication; and
(c) the graphical consent indication substantially surrounds the geometric shape.

12. The system of claim 11, wherein the graphical completion indication and the graphical consent indication comprise a distinct color selected based upon the consent status and the task dataset.

13. The system of claim 11, wherein the geometric shape is a circle and the graphical consent indication comprises a border graphic that substantially surrounds the circle.

14. A method comprising:
(a) configuring a system architecture of a server to comprise an application layer and a database layer, wherein the database layer is configured to store a plurality of student datasets corresponding to a population of students, wherein each student dataset is associated with one student of the population of students, and comprises a task dataset indicating whether any of a plurality of tasks have been performed with that student, a consent status indicating whether consent has been received for performing any of the plurality of tasks with that student, and a set of student information describing personal information and demographic information of that student;
(b) by the server, causing a population status interface to display, on a display of a user device, comprising a description of the plurality of tasks and a completion indicator for each of the plurality of tasks that is based on the task datasets for the plurality of student datasets;
(c) based on a first user input selecting a task portion of the population status interface corresponding to a task of the plurality of tasks, causing a student population interface to display comprising a description of the population of students and, for each student, a description of whether any of the plurality of tasks have been performed with that student; and
(d) based on a second user input selecting a student of the population of students via the student population interface, causing a student specific status interface to display based on a student dataset of the plurality of student datasets for the student, wherein the student specific status interface comprises the description of the plurality of tasks, a graphical consent indication based on the consent status, and a graphical completion indication based on the task dataset.

15. The method of claim 14, further comprising by the server and at the application layer:
(a) receiving personal information for a new student;
(b) encrypting the personal information; and
(c) adding the new student dataset to the plurality of student datasets in the database layer, and adding the encrypted personal information to the set of student information for the new student.

16. The method of claim 15, wherein all personal information stored within the set of student information for each of the plurality of student datasets in the database layer is encrypted.

17. The method of claim 16, further comprising by the server and at the application layer, when querying the database layer for a target student record based upon a database key comprising fields that are encrypted within the database layer:
(a) based upon the database key, creating and executing a broad query that is configured to retrieve a broad query result set that contains the target student record and at least one other student record;
(b) for records of the broad query result set, decrypting fields associated with the database key until the target student record is identified; and
(c) in response to identifying the target student record, decrypting all of the fields of the target student record.

18. The method of claim 17, wherein the application layer is configured to immediately cease decrypting records of the broad query result set after identifying the target student record.

19. The method of claim 18, wherein the decrypted target student record is temporarily stored by the application layer within a particular user session.

20. The method of claim 14, wherein the plurality of tasks comprise a preventative behavioral visit, a preventative medical visit, a parent conference with a nurse practitioner, a parent conference with a social worker, a teacher conference with a nurse practitioner, and a teacher conference with a social worker, and wherein the set of student information comprises a student name, a student birthdate, a description of student immunization status, and a description of student medical status.
